(19) United States
(12) Patent Application Publication
(10) Pub. No.: US 2022/0277203 A1
(43) Pub. Date: Sep. 1, 2022

(54) NON-TRANSITORY COMPUTER-READABLE RECORDING MEDIUM, DATA GENERATION METHOD, AND DATA GENERATION APPARATUS

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/744,783

(22) Filed: May 16, 2022

Related U.S. Application Data
(63) Continuation of application No. PCT/JP2019/047909, filed on Dec. 6, 2019.

(51) Int. Cl. G06N 5/02

(52) U.S. Cl. CPC G06N 5/022; G06Q 50/06

(57) ABSTRACT

A non-transitory computer-readable recording medium storing a data generation program that causes a processor included in a computer to execute a process, the process includes clustering first waveform data indicating electric power at each measurement point consumed during job execution in a system, and generating, using a first method of statistically padding data based on the first waveform data contained in each of clusters and a second method of padding the data based on a feature amount of the data, second waveform data such that a number of pieces of waveform data contained in each of the clusters falls within a predetermined range.

### CROSS-REFERENCE TO RELATED APPLICATION

This application is a continuation application of International Application PCT/JP2019/047909 filed on Dec. 6, 2019 and designated the U.S., the entire contents of which are incorporated herein by reference.

### FIELD

The embodiments discussed herein are related to a data generation program and a data generation method.

### BACKGROUND

The electricity charge paid to the electric power company is worked out by the formula “electricity charge=contracted electric power charge+electric power amount charge unit price x monthly usage amount of electric power”. In addition, the contracted electric power charge is determined by the usage amount of electric power for 30 minutes (maximum demand electric power) in which the electric power was used most in the previous year (past one year). Therefore, if the average electric power for 30 minutes exceeds the contracted electric power even once, the electricity charge for the next fiscal year will increase.

Furthermore, for example, a high performance computer (HPC) or the like consumes a huge amount of electric power, such that the contracted electric power charge becomes high.

Thus, in order to lower the electricity charge, a technique for scheduling jobs such that the contracted electric power is not exceeded is expected. For example, before jobs are executed, the electric power consumed when these jobs are executed is predicted by the classification using information on each job. From after a certain period of time has elapsed since the job execution started, prediction models created for each classified job are used to predict the electric power of each job in time series, using the measured electric power and the models. Then, by integrating the results of the time-series prediction of each job to predict the electric power of all the jobs in time series, job scheduling is performed such that the contracted electric power is not exceeded.

The prediction model is generated by training the actual consumed electric power of jobs executed in the past as training data. Here, when the number of pieces of the training data is not sufficient, for example, n method of making the number of pieces of the training data greater by a data padding technique using a variable auto encoder (VAE) is known.

Regarding the VAE, an information processing device that is capable of reducing labeling work when estimating latent factors, for example, emotions from a plurality of pieces of data and estimates emotions even if loss of any data occurs has been proposed. This device executes machine learning of semi-supervised training using training data and estimates the emotion of a person as the latent factor from observation data, using a model that has finished training, to output the estimated emotion. In addition, this device executes machine learning with a combination of a recurrent neural network (RNN) and the VAE.

Furthermore, regarding the padding of data, a method of predicting the lifetime demand for maintenance parts even when sufficient actual values are not available has been proposed. In this method, for each part and for each year elapsed from the start of maintenance of the parts, the cumulative number of products shipped up to the elapsed years and the normalized amount of demand for parts obtained by transforming the amount of demand for parts per product by a transformation function are calculated, and the parts are classified into groups. In addition, for each group and for each elapsed year in and after the elapsed (k+1) year, this method constructs a linear regression equation for predicting the normalized amount of demand for parts for the elapsed years. Furthermore, this method specifies a group to which the input prediction target part belongs and calculates the predicted value of the amount of part demand for the prediction target part in the prediction target year, using the linear regression equation.

In addition, regarding the electric power prediction, a prediction device that versatilely and highly accurately predicts information regarding electric power consumption, such as load configuration, has been proposed. This prediction device stores a plurality of patterns having a configuration including the values of electric power consumption for each time point and information regarding the electric power consumption and specifies a pattern into which the prediction target is classified, based on the values of electric power consumption of the prediction target for each time point and the values of electric power consumption of each pattern. Then, this prediction device makes an output based on the information regarding the electric power consumption of the specified pattern.

Japanese Laid-open Patent Publication No. 2018-152004, Japanese Laid-open Patent Publication No. 2012-155684, and Japanese Laid-open Patent Publication No. 2015-231328 are disclosed as related art.

### SUMMARY

According to an aspect of the embodiments, a non-transitory computer-readable recording medium storing a data generation program that causes a processor included in a computer to execute a process, the process includes: clustering first waveform data indicating electric power at each measurement point consumed during job execution in a system; and generating, using a first method of statistically padding data based on the first waveform data contained in each of clusters and a second method of padding the data based on a feature amount of the data, second waveform data such that a number of pieces of waveform data contained in each of the clusters falls within a predetermined range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic structure of a prediction system;

FIG. 2 is a diagram illustrating an example of a job electric power database (DB);

FIG. 3 is a diagram for explaining a problem when all waveform data is set as it is for input and output of a VAE;

FIG. 4 is a functional block diagram of a data generation unit;

FIG. 5 is a diagram for explaining the determination of an appropriate number of clusters;

FIG. 6 is a diagram for explaining that the number of pieces of the waveform data per cluster is adjusted to N;

FIG. 7 is a diagram for explaining padding of the waveform data jointly using BOX-COX transformation and the VAE;

FIG. 8 is a diagram for explaining that the number of pieces of padding by the BOX-COX transformation differs depending on the waveform data;

FIG. 9 is a diagram for explaining the determination of an appropriate value of X;

FIG. 10 is a diagram for explaining a case where the waveform data is set for input and output of the VAE for each cluster;

FIG. 11 is a diagram for explaining the creation of a training data set;

FIG. 12 is a block diagram illustrating a schematic structure of a computer that functions as a prediction device;

FIG. 13 is a flowchart illustrating an example of data generation processing;

FIG. 14 is a flowchart illustrating an example of training processing; and

FIG. 15 is a flowchart illustrating an example of prediction processing.

### DESCRIPTION OF EMBODIMENTS

In the related art, if the quality of data padded for use as training data is low, there is a problem that the prediction accuracy by the generated prediction model is degraded.

As one aspect, the disclosed technique aims to generate training data capable of improving the prediction accuracy of a prediction model.

Hereinafter, an example of embodiments according to the disclosed technique will be described with reference to the drawings.

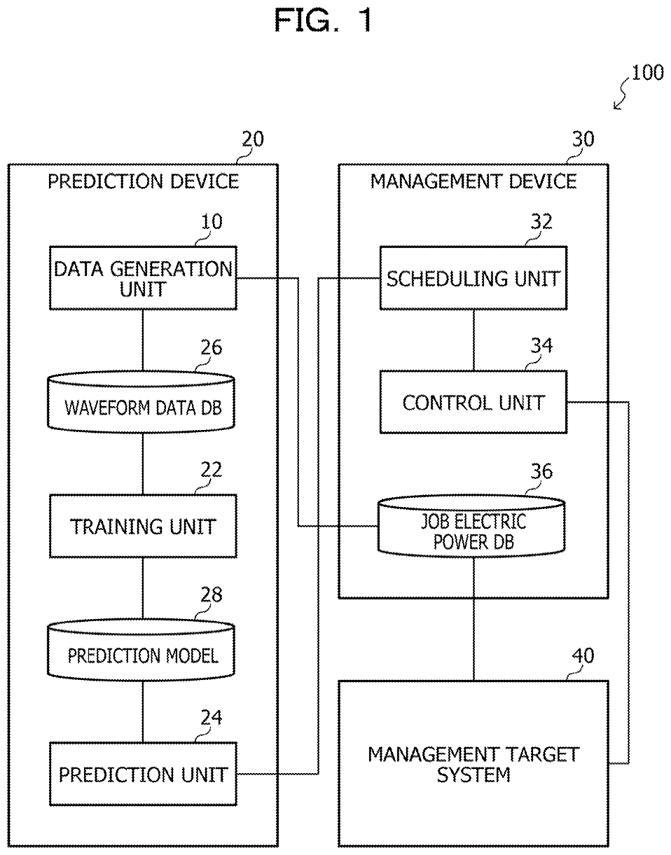

As illustrated in FIG. 1, a prediction system 100 includes a management target system 40 such as a high performance computer (HPC), a management device 30 that manages the management target system 40, and a prediction device 20 that predicts consumed electric power during job execution in the management target system 40.

Functionally, the management device 30 includes a scheduling unit 32 and a control unit 34, as illustrated in FIG. 1. In addition, a job electric power database (DB) 36 is stored in a predetermined storage area of the management device 30.

The scheduling unit 32 determines a schedule relating to the execution of each job. At this time, the scheduling unit 32 determines the schedule of each job such that the total consumed electric power of all jobs does not exceed the contracted electric power, based on the prediction result for the consumed electric power of each job predicted by a prediction unit 24 of the prediction device 20 described later.

The control unit 34 controls the execution of the jobs by outputting an instruction to the management target system 40 such that the jobs are executed in accordance with the schedule determined by the scheduling unit 32.

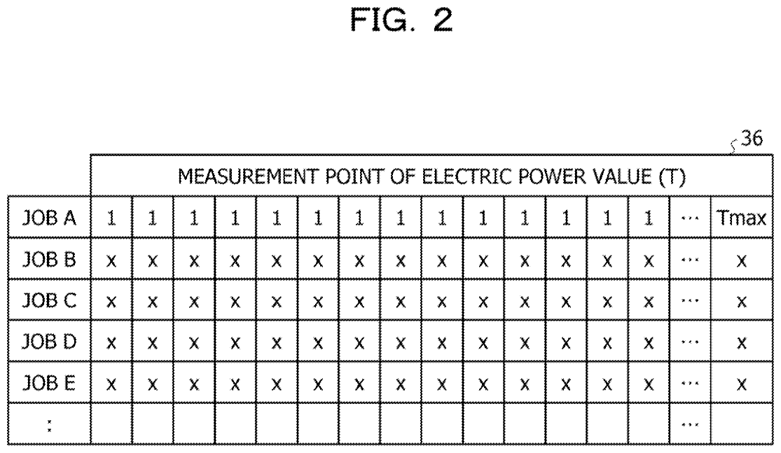

As illustrated in FIG. 2, the job electric power DB 36 stores the consumed electric power for each job measured at each measurement point in the management target system 40. The measurement points are at predetermined time intervals (for example, five-minute intervals) and are designated as a measurement point 1, a measurement point 2, . . . as the time elapses from the start of job execution. In the following, a measurement point i will be denoted as “Ti”. In addition, in the example in FIG. 2, the measurement point corresponding to the maximum job execution time set by a user is designated as “Tmax”. For example, when the maximum job execution time is 24 hours and the time interval between the measurement points is every five minutes, Tmax=T288 is designated.

Functionally, the prediction device 20 includes a data generation unit 10, a training unit 22, and the prediction unit 24, as illustrated in FIG. 1. In addition, a waveform data DB 26 and a prediction model 28 are stored in a predetermined storage area of the prediction device 20. Note that the data generation unit 10 is an example of a data generation device of the disclosed technique.

The data generation unit 10 generates waveform data for training the prediction model 28 that predicts the consumed electric power of each job in the management target system 40. The waveform data is time-series data of the electric power values of each job at each measurement point. For example, the data structure of the waveform data is similar to the electric power values stored in the job electric power DB 36 of the management device 30. Hereinafter, the electric power value stored in the job electric power DB 36 is also referred to as “past waveform data”.

As the waveform data for training the prediction model 28, the above-mentioned past waveform data can be used. Here, when the number of pieces of the past waveform data is small, the prediction model 28 is not allowed to appropriately train. Therefore, the data generation unit 10 generates waveform data by padding the past waveform data.

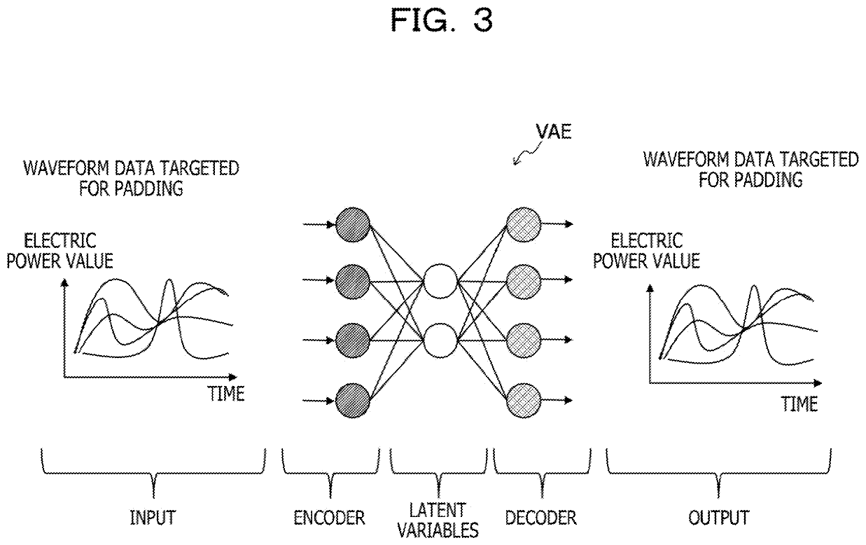

The use of a variable auto encoder (VAE) in this generation of waveform data by padding will be examined. As illustrated in FIG. 3, the VAE includes an encoder, which is a neural network that transforms input data into latent variables, and a decoder, which is a neural network that restores the original input data from the latent variables. At the time of training, the same waveform data group is set for the input and the output, and the latent variables are trained. Then, new waveform data is generated by inputting the waveform data targeted for padding to the VAE that has trained. Since the neural network of the VAE is configured to capture the features of the waveform data, in principle, the waveform data generated by the VAE will be data having features similar to the features of the original waveform data.

However, when the variety of the waveform data targeted for padding is large, variations in the features captured by the neural network at the time of training become large, and appropriate training of the latent variables is not allowed. Waveform data generated by the VAE that has not appropriately trained the latent variables is likely to be of low quality and unsuitable for training the prediction model 28.

Thus, the data generation unit 10 does not perform padding on all the past waveform data, but first performs classification into resembling waveform data groups and then performs padding by targeting only waveform data that contributes to the prediction accuracy. Hereinafter, the data generation unit 10 will be described in detail.

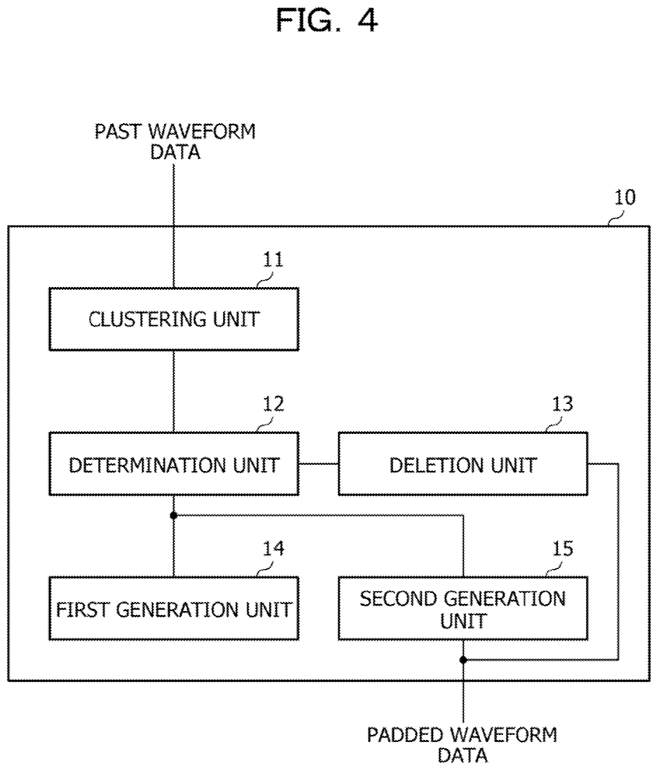

As illustrated in FIG. 4, the data generation unit 10 can be further represented by a structure including a clustering unit 11, a determination unit 12, a deletion unit 13, a first generation unit 14, and a second generation unit 15.

The clustering unit 11 acquires the past waveform data from the job electric power DB 36 of the management device 30 and clusters the acquired waveform data. For clustering, for example, a method such as the k-means method can be used. In addition, the clustering unit 11 determines an appropriate number of clusters at the time of clustering.

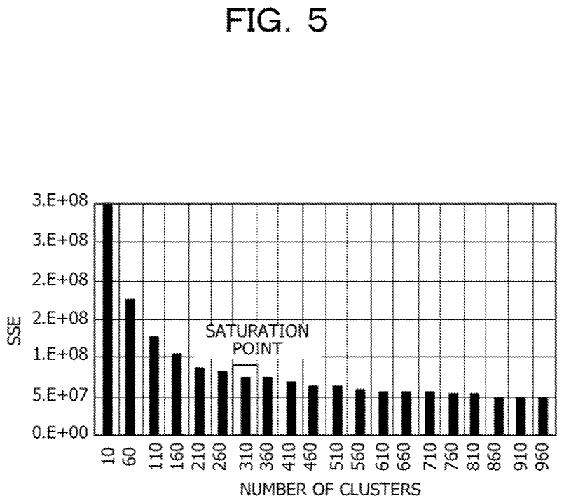

For example, the clustering unit 11 performs clustering while altering the setting of the number of clusters and calculates the sum of variations in the waveform data included in each cluster for all the clusters. As the sum of variations, for example, the sum of squared residuals (sum of squared error (SSE)) between the cluster center and each piece of waveform data can be used. Then, as illustrated in FIG. 5, the clustering unit 11 takes the number of clusters on the horizontal axis and the value of SSE on the vertical axis and specifies a saturation point, for example, by the elbow method or the like. For example, by calculating the rate of decrease in the SSE with respect to the previous number of clusters for each number of clusters, the saturation point can be defined as the number of clusters that gives the rate of decrease equal to or less than a predetermined value (for example, 50% or less) of the rate of decrease of the previous number of clusters.

The clustering unit 11 passes the determined number of clusters and the result of clustering the waveform data with the determined number of clusters to the determination unit 12.

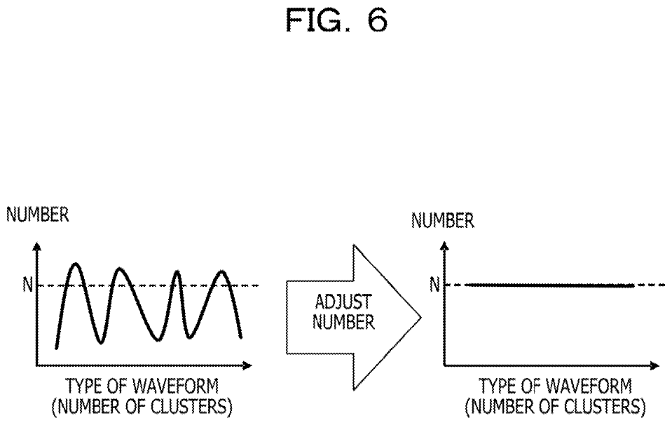

The determination unit 12 determines the number of pieces of waveform data N per cluster desired to be obtained. For example, the determination unit 12 determines N as in “N=the number of all pieces of waveform data/the number of clusters”. As illustrated in FIG. 6, by adjusting the number of pieces of waveform data per cluster to N, the prediction model 28 is allowed to train evenly for various waveform types.

Thus, for clusters in which the number of pieces of the waveform data contained in the cluster exceeds the determined number N, the determination unit 12 passes the waveform data contained in each cluster and the value of N to the deletion unit 13. On the other hand, for clusters in which the number of pieces of the waveform data contained in the cluster is equal to or less than the determined number N, the waveform data contained in each cluster and the value of N are passed to the first generation unit 14 and the second generation unit 15.

Here, in the present embodiment, the first generation unit 14 that statistically pads data and the second generation unit 15 that pads data based on the feature amount of the data are used jointly to generate the waveform data such that the number of pieces of the waveform data contained in each cluster coincides with N. In the present embodiment, the case where the first generation unit 14 performs padding by the BOX-COX transformation and the second generation unit 15 performs padding by the VAE will be described. The reason for jointly using the two methods will be explained below.

Since the clustering unit 11 performs clustering based on the Euclid distance, the number of pieces of the waveform data in each cluster becomes unbalanced. For example, when 392 jobs are classified into 20 clusters, there is a case where the number of pieces of the waveform data classified into each cluster is designated as (126, 2, 1, 29, 1, 12, 197, 1, 2, 1, 1, 1, 11, 1, 1, 1, 1, 1, 1, 1). In this example, there are clusters that contain a lot of pieces of the waveform data, while there are clusters that contain only one piece of the waveform data.

As described earlier, the VAE captures the feature amount of the data by the neural networks, which are an encoder and the decoder, and pads the data using the captured feature amount. In the method of padding the data based on the feature amount in this manner, since the randomness of the data obtained by the padding is high, high quality data suitable for use as training data may be generated. For example, since the padding is based on the feature amount, data in which a feature desired to be trained is reflected may be appropriately padded. However, since the feature amount of the data may not be captured if the number of pieces of the original data is too small, padding is not allowed to be performed when the original data is less than a predetermined number (at least about 100).

On the other hand, when padding is performed by a statistical method such as the BOX-COX transformation that performs transformation for bringing data closer to a normal distribution, padding is feasible for even one piece of the original data. However, in the case of the statistical method, the padded data has low randomness, and the quality of the data as the training data is inferior as compared with the method based on the feature amount, such as in the VAE.

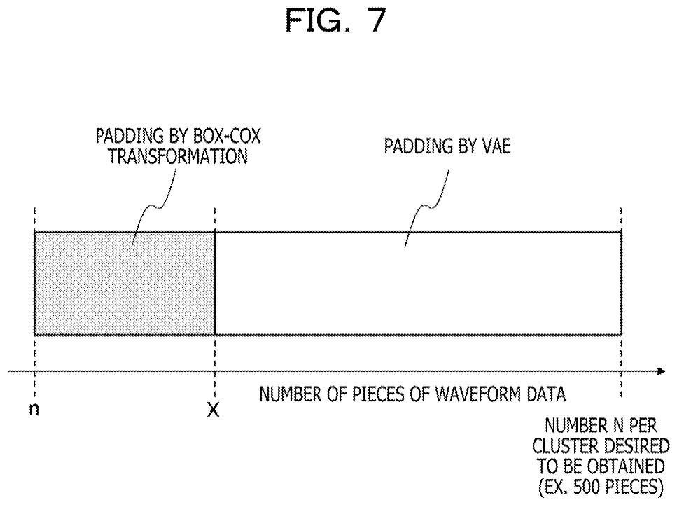

Thus, in the present embodiment, as illustrated in FIG. 7, the number of pieces of waveform data n contained in each cluster is padded by the BOX-COX transformation up to a number X to which the VAE is applicable, and then padding up to the number N desired to be obtained per cluster is performed by the VAE.

Here, when the waveform data is padded up to X pieces using the BOX-COX transformation, the generation of high-quality waveform data by the VAE may be maximized by appropriately assigning X. However, the appropriate value of X is unknown and is also different depending on the waveform data contained in each cluster.

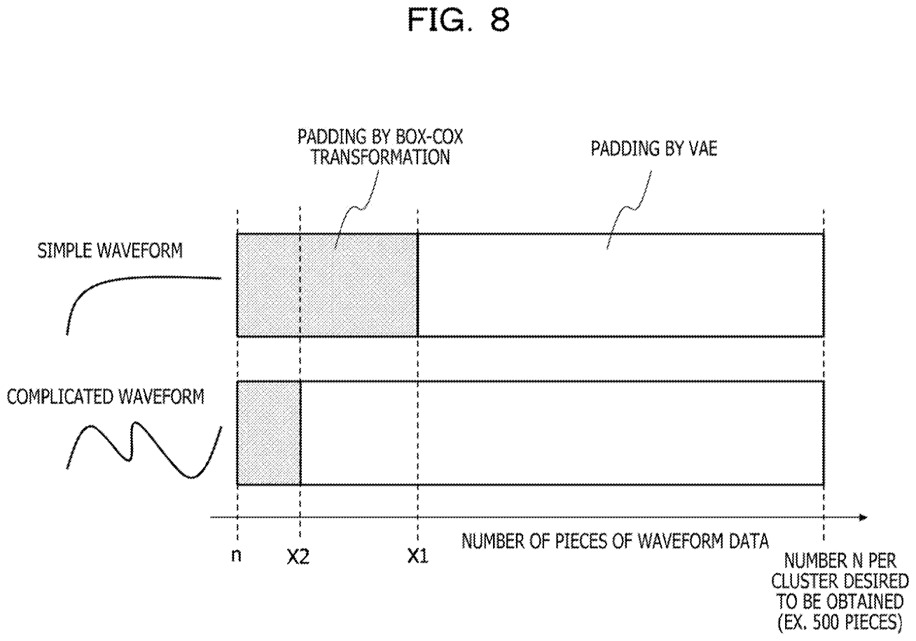

For example, as illustrated in FIG. 8, when the shape of a waveform indicated by the waveform data is simple, a change in that waveform is moderate, and it is difficult for the VAE to capture the feature amount. Therefore, for training of the latent variables of the VAE, a lot of pieces of base waveform data are involved (X1 in FIG. 8). On the other hand, when the shape of a waveform is complicated, since it is easy for the VAE to capture the feature amount, the latent variables of the VAE may be trained even if the number of pieces of the base waveform data is small (X2 in FIG. 8).

Thus, the determination unit 12 determines X in a case where the waveform data is padded up to X using the BOX-COX transformation, for each cluster. For example, the determination unit 12 causes the first generation unit 14 to generate up to X pieces of waveform data and the second generation unit 15 to generate up to N pieces of waveform data for each of a plurality of values of X to form first waveform data groups. In addition, the determination unit 12 causes only the second generation unit 15 to generate up to N pieces of waveform data to form a second waveform data group. The determination unit 12 determines X for each cluster, based on the similarity between the first waveform data group and the second waveform data group. Considering that the waveform data is evaluated between jobs with different execution times, the similarity can be calculated by dynamic time warping (DTW) from between averages of both of the waveform data groups.

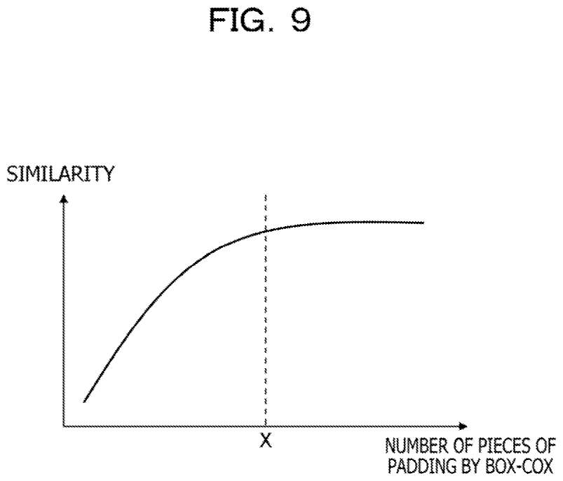

As illustrated in FIG. 9, the determination unit 12 determines an appropriate value of X from the change in similarity with respect to the value of X. When the similarity is high, it is indicated that the difference between a case where padding is performed using the BOX-COX transformation and a case where padding is performed by the VAE alone is small, which indicates that it is feasible for the VAE to generate high quality waveform data without performing padding by the BOX-COX transformation. Accordingly, it is desirable to determine a small value of X that gives as high similarity as possible.

For example, the determination unit 12 is capable of searching for and determining the optimum X by applying a Gaussian process to the change in similarity with respect to the value of X illustrated in FIG. 9 above. By using the Gaussian process in the search algorithm, the optimum value may be found by search with the minimum number of searches when the change in the value has an upwardly convex shape.

In addition, considering that there is also a case where the VAE is sufficiently applicable only with the waveform data contained in the cluster, the determination unit 12 may verify the similarity between the first waveform data group and the second waveform data group with a threshold value. For example, the determination unit 12 calculates the similarity between the first waveform data group obtained by generating up to (N−n)×0.5 pieces by the BOX-COX transformation and generating up to N pieces by the VAE and the second waveform data group obtained by generating up to N pieces by the VAE alone. Then, when the similarity is equal to or higher than the threshold value, the determination unit 12 may generate up to N pieces of waveform data by the VAE and, when the similarity is less than the threshold value, may search for an appropriate X as described above to generate waveform data by jointly using the BOX-COX transformation and the VAE.

The determination unit 12 notifies the second generation unit 15 of the determined value of X (including the case of X=0).

The deletion unit 13 randomly deletes the waveform data contained in the cluster passed from the determination unit 12 such that the number of pieces of the waveform data contained in that cluster coincides with N. Note that, since similar pieces of waveform data are contained in the same cluster, no problem arises even if the waveform data to be deleted is randomly selected.

The deletion unit 13 stores the N pieces of waveform data after the deletion in the waveform data DB 26.

As described above, the first generation unit 14 generates waveform data by a statistical method (the BOX-COX transformation in the present embodiment) in the process of determining X. For example, under the instruction of the determination unit 12, the first generation unit 14 generates up to X pieces of waveform data for each cluster by the BOX-COX transformation while altering the value of X and passes the generated waveform data to the determination unit 12 and the second generation unit 15.

As described above, the second generation unit 15 generates waveform data by a method based on the feature amount (the VAE in the present embodiment) in the process of determining X. For example, under the instruction of the determination unit 12, the second generation unit 15 uses the waveform data contained in the cluster and the (X−n) pieces of waveform data passed from the first generation unit 14 to generate (N−X) pieces of waveform data by the VAE for each cluster. Note that there is a case X is 0, and in this case, there is no waveform data passed from the first generation unit 14.

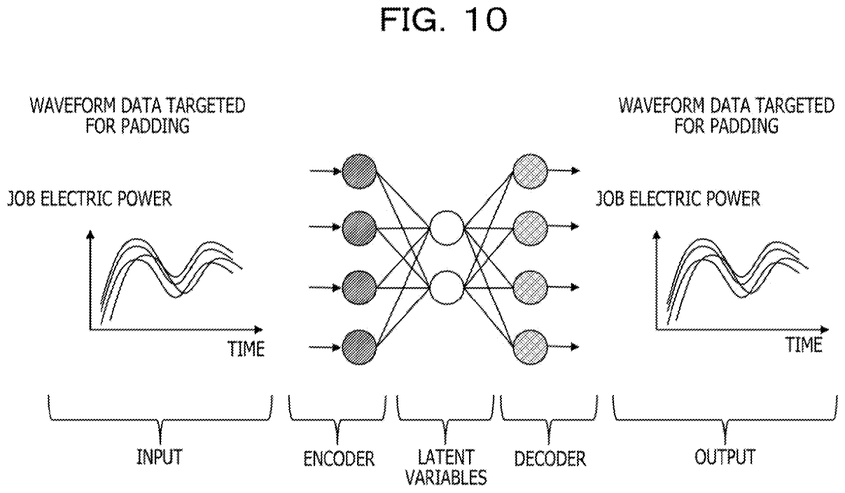

By applying the VAE to each cluster in the second generation unit 15, as illustrated in FIG. 10, the waveform data group set for each of the input and output of the VAE will have pieces of waveform data contained in the set waveform data group similar to each other. This advances the training of the latent variables of the VAE appropriately and enhances the quality of the waveform data generated by the VAE that has finished training.

In addition, when notified of the value of X by the determination unit 12, the second generation unit 15 stores the (X−n) pieces of waveform data passed from the first generation unit 14, the generated (N−X) pieces of waveform data, and n pieces of waveform data contained in the cluster, in the waveform data DB 26, for the notified value of X.

This will store k, which is the number of clusters, ×N pieces of waveform data in the waveform data DB 26 as training data for each job. The data structure of the waveform data DB 26 is similar to the data structure of the job electric power DB 36 illustrated in FIG. 2.

The training unit 22 trains the parameters of the prediction model 28, using the waveform data stored in the waveform data DB 26. For example, as the prediction model 28, a recurrent neural network (RNN), which is a training method for time-series data, or the like can be used. In the RNN, the contents of the hidden layer at a time point t are treated as the input of the following time point t+1.

For example, the training unit 22 formats each piece of waveform data. For example, in a period during which the electric power value has not yet been obtained (from the present time to the maximum job execution time), and when the job has already been completed, the training unit 22 designates the electric power values for each measurement point from the job end time point to the maximum job execution time, as zero.

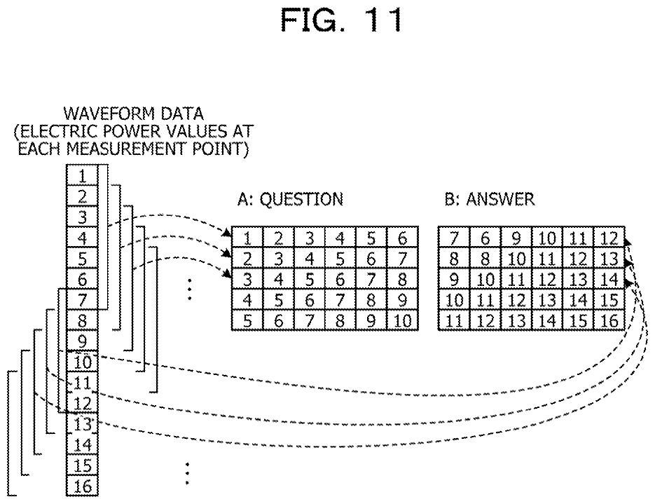

As illustrated in FIG. 11, the training unit 22 extracts a question (A) part and an answer (B) part from the formatted waveform data while shifting by one measurement point and creates a training data set. The question (A) corresponds to the time-series data of the electric power value input to the prediction model 28 at the time of prediction, and the answer (B) corresponds to the correct answer of the time-series data of the electric power value for the time after the prediction with respect to the time-series data input to the prediction model 28. For example, the example in FIG. 11 represents a case where, when electric power values at T1 to T6 are input, electric power values at T7 to T12 are predicted.

The training unit 22 trains the parameters of the prediction model 28 by associating the question (A) and the answer (B) of the created training data set.

When the execution of a job whose electric power value is targeted for prediction is started, the prediction unit 24 acquires the waveform data of the relevant job and formats the waveform data in a manner similar to the training unit 22. The prediction unit 24 extracts the time-series data of the electric power value for the same measurement points as the question (A) at the time of training from the formatted waveform data, inputs the extracted time-series data to the prediction model 28, predicts the time-series data of the electric power value for the succeeding time, and outputs the prediction result to the scheduling unit 32 of the management device 30.

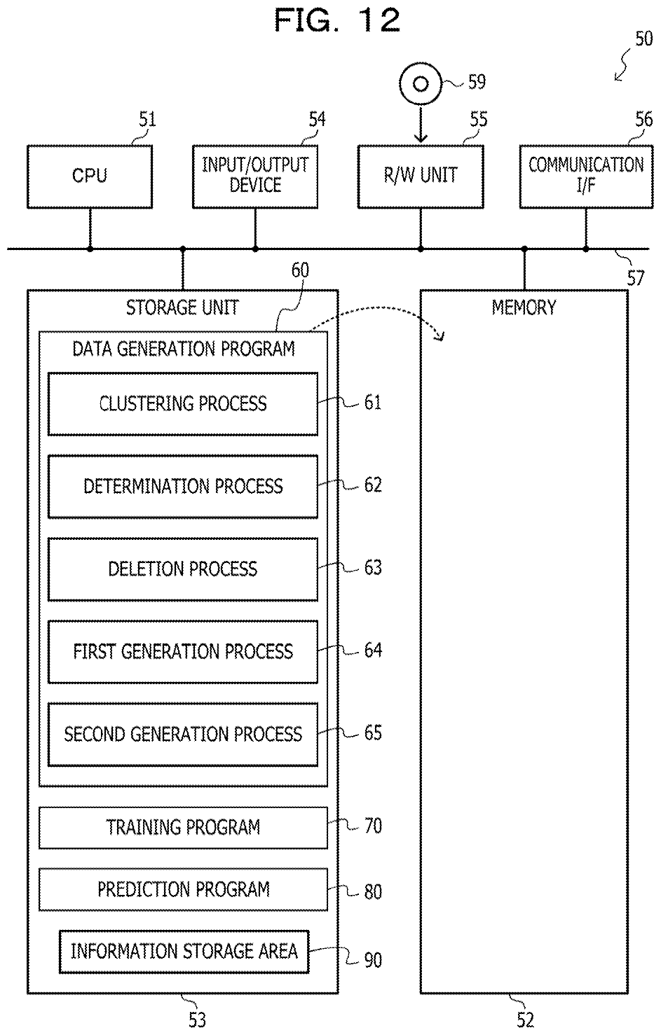

The prediction device 20 may be implemented by a computer 50 illustrated in FIG. 12, for example. The computer 50 includes a central processing unit (CPU) 51, a memory 52 as a temporary storage area, and a nonvolatile storage unit 53. In addition, the computer 50 includes an input/output device 54 such as an input unit and a display unit, and a read/write (R/W) unit 55 that controls reading and writing of data from and to a storage medium 59. Furthermore, the computer 50 includes a communication interface (I/F) 56 connected to a network such as the Internet. The CPU 51, the memory 52, the storage unit 53, the input/output device 54, the R/W unit 55, and the communication I/F 56 are coupled to each other via a bus 57.

The storage unit 53 may be implemented by a hard disk drive (HDD), a solid state drive (SSD), a flash memory, or the like. A data generation program 60, a training program 70, and a prediction program 80 for causing the computer 50 to function as the prediction device 20 are stored in the storage unit 53 as a storage medium. The data generation program 60 includes a clustering process 61, a determination process 62, a deletion process 63, a first generation process 64, and a second generation process 65. In addition, the storage unit 53 includes an information storage area 90 in which information constituting each of the waveform data DB 26 and the prediction model 28 is stored.

The CPU 51 reads the data generation program 60 from the storage unit 53 to load the data generation program 60 into the memory 52 and sequentially executes the processes included in the data generation program 60. The CPU 51 executes the clustering process 61 to operate as the clustering unit 11 illustrated in FIG. 4. In addition, the CPU 51 executes the determination process 62 to operate as the determination unit 12 illustrated in FIG. 4. In addition, the CPU 51 executes the deletion process 63 to operate as the deletion unit 13 illustrated in FIG. 4. In addition, the CPU 51 executes the first generation process 64 to operate as the first generation unit 14 illustrated in FIG. 4. In addition, the CPU 51 executes the second generation process 65 to operate as the second generation unit 15 illustrated in FIG. 4. In addition, the CPU 51 reads information from the information storage area 90 and loads each of the waveform data DB 26 and the prediction model 28 into the memory 52.

Furthermore, the CPU 51 reads the training program 70 from the storage unit 53, loads the read training program 70 into the memory 52, and executes the loaded training program 70 to operate as the training unit 22 illustrated in FIG. 1. In addition, the CPU 51 reads the prediction program 80 from the storage unit 53, loads the read prediction program 80 into the memory 52, and executes the loaded prediction program 80 to operate as the prediction unit 24 illustrated in FIG. 1. This will cause the computer 50 that has executed the data generation program 60, the training program 70, and the prediction program 80 to function as the prediction device 20. Note that the CPU 51 that executes the programs is hardware.

In addition, functions implemented by each program can also be implemented, for example, by a semiconductor integrated circuit, in more detail, an application specific integrated circuit (ASIC) or the like.

Note that, since the hardware structure of the management device 30 can be implemented by a computer including a CPU, a memory, a storage unit, an input/output device, an R/W unit, a communication I/F, and the like, as in the prediction device 20, detailed description will be omitted.

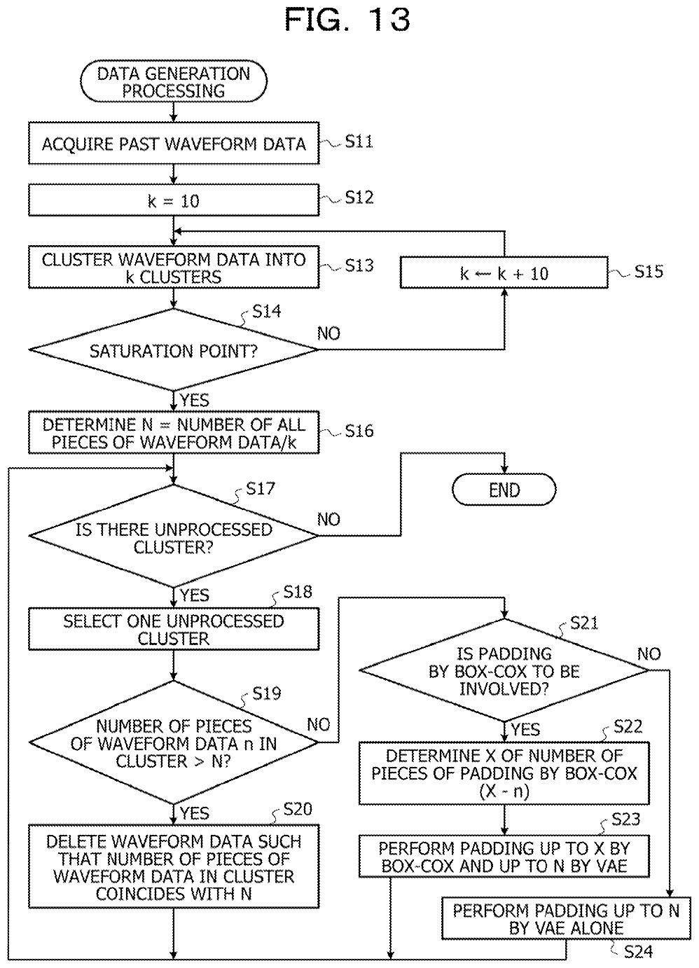

Next, an action of the prediction system 100 according to the present embodiment will be described. Jobs are executed in the management target system 40 under the control of the management device 30. In consequence of the execution of the jobs, the consumed electric power of each job measured at each measurement point by the management target system 40 is stored in the job electric power DB 36 of the management device 30. Then, at a predetermined timing (for example, every seven days), data generation processing illustrated in FIG. 13 is executed in the prediction device 20. Note that the data generation processing is an example of a data generation method of the disclosed technique.

In step S11, the clustering unit 11 acquires the past waveform data from the job electric power DB 36 of the management device 30.

Next, in step S12, the clustering unit 11 sets an initial value (for example, 10) in a variable k representing the number of clusters.

Next, in step S13, the clustering unit 11 clusters the acquired waveform data into k clusters, for example, using a method such as the k-means method.

Next, in step S14, the clustering unit 11 calculates the SSE of the number of clusters k and verifies, by the elbow method, whether or not the number of clusters k coincides with the saturation point in a graph where the horizontal axis denotes the number of clusters and the vertical axis denotes the value of the SSE. In the case of coinciding with the saturation point, the clustering unit 11 passes the number of clusters k and the result of clustering the waveform data with the number of clusters k to the determination unit 12, and the processing proceeds to step S16. On the other hand, in the case of not coinciding with the saturation point, the processing proceeds to step S15, the clustering unit 11 adds a predetermined value (for example, 10) to k to alter the number of clusters, and the processing returns to step S13.

In step S16, the determination unit 12 uses the number of clusters k and the clustering result passed from the clustering unit 11 to determine the number of pieces of waveform data N desired to be obtained per cluster, for example, as in “N=the number of all pieces of waveform data/k”.

Next, in step S17, the determination unit 12 verifies whether or not, among the clusters included in the clustering result passed from the clustering unit 11, there is a cluster for which the subsequent processing has not been processed. When there is an unprocessed cluster, the processing proceeds to step S18, and the determination unit 12 selects one unprocessed cluster.

Next, in step S19, the determination unit 12 verifies whether or not the number of pieces of waveform data n in the selected cluster exceeds N determined in above step S16. When n>N holds, the determination unit 12 passes the waveform data contained in the selected cluster and the value of N to the deletion unit 13, and the processing proceeds to step S20. On the other hand, when n≤N holds, the processing proceeds to step S21.

In step S20, the deletion unit 13 randomly deletes the waveform data contained in the cluster passed from the determination unit 12 such that the number of pieces of the waveform data contained in that cluster coincides with N. Then, the deletion unit 13 stores the N pieces of waveform data after the deletion in the waveform data DB 26, and the processing returns to step S17.

Meanwhile, in step S21, the determination unit 12 verifies whether or not padding of the waveform data by the BOX-COX transformation is to be involved for the selected cluster. For example, the determination unit 12 passes the waveform data contained in the selected cluster and the value of N to the first generation unit 14 and the second generation unit 15. Then, the determination unit 12 causes the first generation unit 14 to generate up to (N−n)×0.5 pieces of waveform data by the BOX-COX transformation and causes the second generation unit 15 to generate up to N pieces of waveform data by the VAE to form the first waveform data group. In addition, the determination unit 12 causes the second generation unit 15 to generate up to N pieces of waveform data by the VAE to form the second waveform data group. Then, the determination unit 12 calculates the similarity between the first waveform data group and the second waveform data group.

When the similarity is equal to or higher than the threshold value, the determination unit 12 verifies that padding of the waveform data by the BOX-COX transformation is not to be involved and notifies the second generation unit 15 that X =0 is employed, and the processing proceeds to step S24. On the other hand, when the similarity is less than the threshold value, the determination unit 12 verifies that padding of the waveform data by the BOX-COX transformation is to be involved, and the processing proceeds to step S22.

In step S22, the determination unit 12 causes the first generation unit 14 to generate up to X pieces of waveform data and causes the second generation unit 15 to generate up to N pieces of waveform data for each of a plurality of values of X to form the first waveform data groups. The determination unit 12 applies the Gaussian process to the change in the similarity between the first waveform data group and the second waveform data group with respect to the value of X to search for and determine the optimum X and notifies the second generation unit 15 of the determined value of X.

Next, in step S23, the waveform data generated up to N pieces by the second generation unit 15 for the value of X notified by the determination unit 12 by jointly using the BOX-COX transformation and the VAE in the process of determining X is stored in the waveform data DB 26. For example, the second generation unit 15 stores the (X−n) pieces of waveform data passed from the first generation unit 14, the generated (N−X) pieces of waveform data, and n pieces of waveform data contained in the cluster, in the waveform data DB 26. Then, the processing returns to step S17.

Meanwhile, in step S24, the second generation unit 15 stores waveform data generated up to N pieces by the VAE alone in the process of determining X, in the waveform data DB 26. For example, the second generation unit 15 stores the generated (N−n) pieces of waveform data and n pieces of waveform data contained in the cluster, in the waveform data DB 26. Then, the processing returns to step S17.

When the determination unit 12 verifies, in step S17, that the processing has ended for all the clusters, the data generation processing ends.

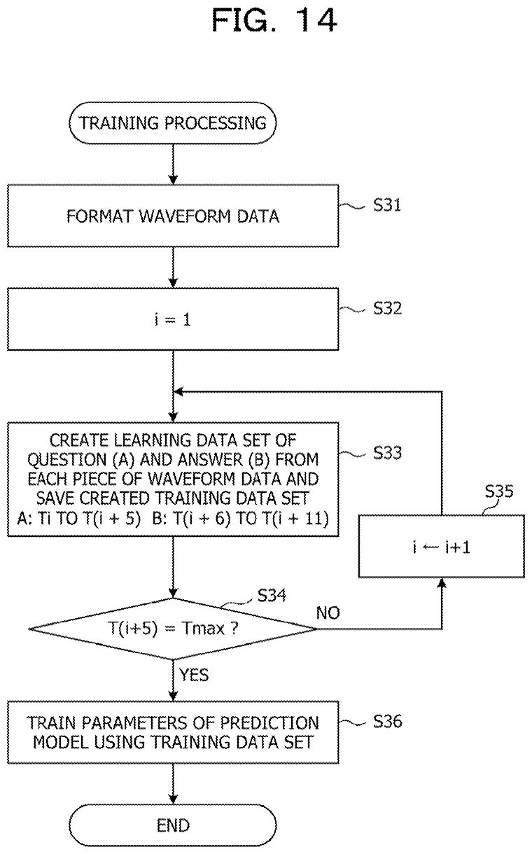

In addition, training processing illustrated in FIG. 14 is executed in the prediction device 20 at a predetermined timing (for example, every month) for generating the prediction model 28. In the present embodiment, a case will be described in which the prediction model 28 that uses the time-series data of the electric power values for six measurement points to predict the time-series data of the electric power values for six measurement points immediately after those six measurement points is generated.

In step S31, the training unit 22 acquires the waveform data stored in the waveform data DB 26. Then, from the present time to the maximum job execution time of each piece of waveform data, and in a case where the job has already been completed, the training unit 22 designates the electric power values for each measurement point from the job end time point to the maximum job execution time, as zero and formats each piece of waveform data.

Next, in step S32, the training unit 22 sets one in a variable i for specifying the measurement point.

Next, in step S33, the training unit 22 extracts the time-series data of the electric power values at measurement points Ti to T(i+5), which corresponds to the question (A), and the time-series data of the electric power values at measurement points T(i+6) to T(i+11), which correspond to the answer (B), from the formatted waveform data. Then, the training unit 22 creates the extracted question (A) and answer (B) as a training data set and saves the created training data set in a predetermined storage area.

Next, in step S34, the training unit 22 verifies whether or not T(i+5) has reached the measurement point Tmax corresponding to the maximum job execution time. When T(i+5)=Tmax holds, the processing proceeds to step S36. On the other hand, when T(i+5) has not reached Tmax yet, the processing proceeds to step S35, the training unit 22 increments i by one, and the processing returns to step S33.

In step S36, the training unit 22 trains the parameters of the prediction model 28 by associating the question (A) and the answer (B) of the created training data set and stores the trained parameters in a predetermined storage area, and the training processing ends.

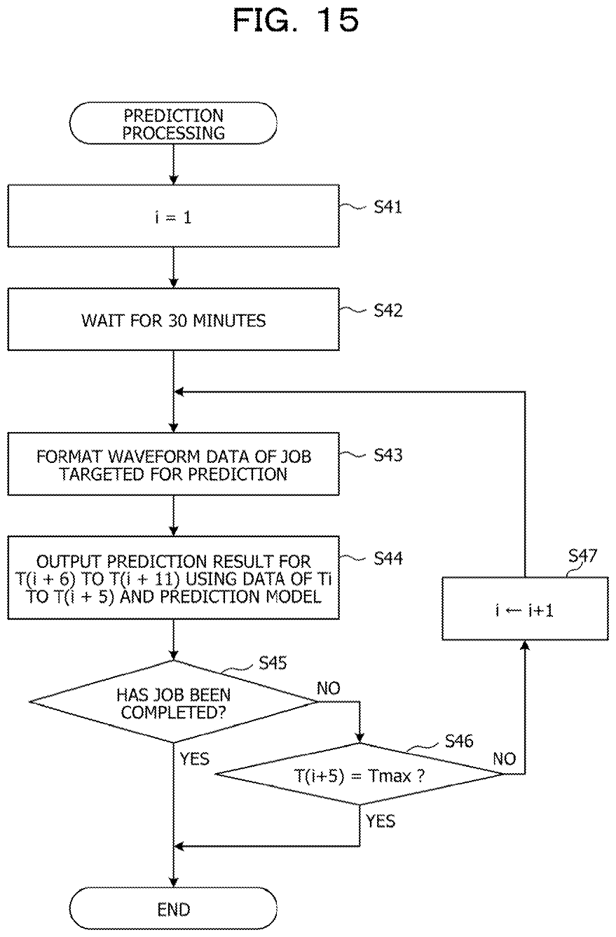

In addition, each time the execution of a job whose electric power value is targeted for prediction is started, prediction processing illustrated in FIG. 15 is executed in the prediction device 20.

In step S41, the prediction unit 24 sets one in the variable i for specifying the measurement point.

Next, in step S42, a predetermined time is waited until the time-series data of the electric power value used for the initial prediction is acquired. In the present embodiment, since the time-series data of the electric power values for the six measurement points is used for prediction, 30 minutes will be waited when it is assumed that the measurement points are at five-minute intervals.

Next, in step S43, the prediction unit 24 acquires the waveform data of the job targeted for prediction from the job electric power DB 36 of the management device 30 and formats the acquired waveform data in a manner similar to step S31 of the training processing.

Next, in step S44, the prediction unit 24 extracts the time-series data of the electric power values at the measurement points Ti to T(i+5) from the waveform data that has been formatted and inputs the extracted time-series data to the prediction model 28. Then, the prediction unit 24 outputs the prediction result of the time-series data of the electric power values at the measurement points T(i+6) to T(i+11) obtained from the prediction model 28 to the scheduling unit 32 of the management device 30.

Next, in step S45, the prediction unit 24 verifies whether or not the job targeted for prediction has been completed. This verification can be made based on whether or not a notification of the completion of the job has been made by the management device 30, whether or not the electric power values continuously have zero at a predetermined number or more of measurement points, and the like. When the job has been completed, the prediction processing ends, and when the job has not been completed, the processing proceeds to step S46.

In step S46, the prediction unit 24 verifies whether or not T(i+5) has reached the measurement point Tmax. When T(i+5)=Tmax holds, the prediction processing ends. On the other hand, when T(i+5) has not reached Tmax yet, the processing proceeds to step S47, and the prediction unit 24 increments i by one. Then, after waiting for a predetermined time (here, five minutes) in order to wait for the electric power value for the next one measurement point to be acquired by the execution of the job, the processing returns to step S43.

As described above, according to the prediction system in the present embodiment, in the prediction device, the data generation unit clusters the waveform data and performs padding by targeting only waveform data that contributes to the prediction accuracy. The waveform data that contributes to the prediction accuracy is waveform data of a cluster in which the number of pieces of waveform data contained in the cluster is less than a predetermined range. By applying the VAE to this cluster to perform padding, the waveform data group set for each of the input and output of the VAE will have pieces of waveform data contained in the set waveform data group similar to each other. This advances the training of the latent variables of the VAE appropriately and enhances the quality of the waveform data generated by the VAE that has finished training. In addition, when the number of pieces of waveform data contained in the cluster is small and the VAE is not applicable, the waveform data is padded to an appropriate number by the BOX-COX transformation, and then the VAE is applied. This makes the VAE applicable and may maximize the generation of high-quality waveform data by the VAE. By using the padded waveform data for training the prediction model in this manner, the prediction accuracy of the prediction model may be improved.

Note that, in the above embodiment, the BOX-COX transformation has been described as an example of the statistical method for padding waveform data, and the VAE has been described as an example of the method based on the feature amount, but the embodiment is not limited to these examples. For example, another method such as the Jain-Dubes method as a statistical method and the hostile generation network as a method based on the feature amount may be applied.

Furthermore, in the above-described embodiment, a mode in which the data generation program is stored (installed) in the storage unit in advance has been described, but the embodiment is not limited to this mode. The program according to the disclosed technique may also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data generation program that causes a processor included in a computer to execute a process, the process comprising:
clustering first waveform data indicating electric power at each measurement point consumed during job execution in a system; and
generating, using a first method of statistically padding data based on the first waveform data contained in each of clusters and a second method of padding the data based on a feature amount of the data, second waveform data such that a number of pieces of waveform data contained in each of the clusters falls within a predetermined range.

2. The non-transitory computer-readable recording medium according to claim 1, wherein the generating includes:
generating third waveform data by the first method until the number of pieces of the waveform data contained in the clusters coincides with a predetermined number for the clusters in which the number of pieces of the first waveform data contained in the clusters is less than the predetermined range, and
generating the second waveform data by the second method based on the waveform data contained in the clusters and the third waveform data generated by the first method until the number of pieces of the waveform data contained in the clusters falls within the predetermined range.

3. The non-transitory computer-readable recording medium according to claim 2,
wherein the predetermined number is determined based on similarity between a first waveform data group generated by using the first method and the second method and a second waveform data group generated by the second method.

4. The non-transitory computer-readable recording medium according to claim 3,
wherein a Gaussian process is applied to a value of the similarity with respect to the number of pieces of the first waveform data generated by the first method, and an optimum value as the predetermined number is determined.

5. The non-transitory computer-readable recording medium according to claim 3, wherein the generating incudes:
generating, when the similarity between a first waveform data group and a second waveform data group is equal to or more than a threshold value, (N−n) pieces of the second waveform data by the second method, and
generating, when the similarity between the first waveform data group and the second waveform data group is less than a threshold value, X pieces of the third waveform data by the first method and generating N pieces of the second waveform data by the second method,
wherein the first waveform data group is generated up to (N−n)×0.5 pieces by the first method and up to N pieces by the second method and a second waveform data group is generated up to the N pieces by the second method,
n is with the number of pieces of the first waveform data contained in any one of the clusters,
N is the number contained in the predetermined range, and
X is the predetermined number as X.

6. The non-transitory computer-readable recording medium according to a claim 1,
wherein the number of the clusters that is appropriate is determined in the clustering the first waveform data.

7. The non-transitory computer-readable recording medium according to claim 6,
wherein the number of the clusters is determined by an elbow method.

8. The non-transitory computer-readable recording medium according to claim 1,
wherein the predetermined range includes a range with reference to a value obtained by dividing the number of all pieces of the first waveform data by the number of the clusters.

9. The non-transitory computer-readable recording medium according to claim 1,
wherein for the clusters in which the number of pieces of the first waveform data contained in the clusters exceeds the predetermined range, the first waveform data contained in the clusters is randomly deleted such that the number of pieces of the first waveform data contained in the clusters falls within the predetermined range.

10. The non-transitory computer-readable recording medium according to claim 1,
wherein the first method is BOX-COX transformation or a Jain-Dubes method, and the second method is a variable auto encoder (VAE) or a hostile generation network.

11. A data generation method comprising:
clustering first waveform data indicating electric power at each measurement point consumed during job execution in a system; and
generating, using a first method of statistically padding data based on the first waveform data contained in each of clusters and a second method of padding the data based on a feature amount of the data, second waveform data such that a number of pieces of waveform data contained in each of the clusters falls within a predetermined range.

12. The data generation method according to claim 11, wherein the generating includes:
generating third waveform data by the first method until the number of pieces of the waveform data contained in the clusters coincides with a predetermined number for the clusters in which the number of pieces of the first waveform data contained in the clusters is less than the predetermined range, and
generating the second waveform data by the second method based on the waveform data contained in the clusters and the third waveform data generated by the first method until the number of pieces of the waveform data contained in the clusters falls within the predetermined range.

13. The data generation method according to claim 12,
wherein the predetermined number is determined based on similarity between a first waveform data group generated by using the first method and the second method and a second waveform data group generated by the second method.

14. The data generation method according to claim 13,
wherein a Gaussian process is applied to a value of the similarity with respect to the number of pieces of the first waveform data generated by the first method, and an optimum value as the predetermined number is determined.

15. The data generation method according to claim 13, wherein the generating incudes:
generating, when the similarity between a first waveform data group and a second waveform data group is equal to or more than a threshold value, (N−n) pieces of the second waveform data by the second method, and
generating, when the similarity between the first waveform data group and the second waveform data group is less than a threshold value, X pieces of the third waveform data by the first method and generating N pieces of the second waveform data by the second method,
wherein the first waveform data group is generated up to (N−n)×0.5 pieces by the first method and up to N pieces by the second method and a second waveform data group is generated up to the N pieces by the second method,
n is with the number of pieces of the first waveform data contained in any one of the clusters,
N is the number contained in the predetermined range, and
X is the predetermined number as X.

16. The data generation method according to a claim 11,
wherein the number of the clusters that is appropriate is determined in the clustering the first waveform data.

17. The data generation method according to claim 16,
wherein the number of the clusters is determined by an elbow method.

18. The data generation method according to claim 11,
wherein the predetermined range includes a range with reference to a value obtained by dividing the number of all pieces of the first waveform data by the number of the clusters.

19. A data generation apparatus comprising:
a memory; and
a processor coupled to the memory and configured to:
cluster first waveform data indicating electric power at each measurement point consumed during job execution in a system, and
generate, using a first method of statistically padding data based on the first waveform data contained in each of clusters and a second method of padding the data based on a feature amount of the data, second waveform data such that a number of pieces of waveform data contained in each of the clusters falls within a predetermined range.
